(19) United States
(12) Patent Application Publication
(10) Pub. No.: US 2013/0074669 A1
(43) Pub. Date: Mar. 28, 2013

(54) MODULAR ALL IN ONE WINDOW COVERING CUTDOWN MACHINE

(71) Applicants: Cletis Frazier Swopes, Janesville, WI (US); Steven John Neumaier, Sauk City, WI (US)

(72) Inventors: Cletis Frazier Swopes, Janesville, WI (US); Steven John Neumaier, Sauk City, WI (US)

(21) Appl. No.: 13/685,163

(22) Filed: Nov. 26, 2012

Related U.S. Application Data
(63) Continuation of application No. PCT/US11/38199, filed on May 26, 2011.
(60) Provisional application No. 61/348,508, filed on May 26, 2010.

(51) Int. Cl. E06B 9/266

(52) U.S. Cl. CPC E06B 9/266
USPC 83/76.9; 83/859; 83/100; 83/76.6

(57) ABSTRACT

A modular cutdown machine for window coverings includes a center control module and first and second cutting modules at opposite ends of the center control module. Control, power and cleanup functions are contained within the center control module and are distributed to each of the cutting modules. One cutting module can be operated without the other cutting module in place, and repair or service can be performed by the interchange of modules.

### CROSS REFERENCE TO RELATED APPLICATIONS

This is a continuation of PCT application No. PCT/US2011/038199, entitled “MODULAR ALL IN ONE WINDOW COVERING CUTDOWN MACHINE”, filed May 26, 2011, which claims the benefits of United States Provisional Application Ser. No. 61/348,508 filed May 26, 2010, which are incorporated herein by reference.

### FIELD OF THE INVENTION

The present invention relates to cutting apparatus and methods for trimming window coverings such as window blinds that are trimmed at the time of purchase at retail stores.

### BACKGROUND OF THE INVENTION

Different approaches have evolved to prepare window blinds and other window coverings to be of the dimensions needed to cover a particular window (or other architectural opening) for a specific customer. In one approach, an installer or decorator measures the opening to determine the appropriate dimensions, and a window covering is ordered from the manufacturer or fabricator, where the blind is built to the required dimensions. The completed blind is shipped and installed. While custom manufacturing normally provides a blind of the appropriate size, a disadvantage of this procedure is the time required, whereby several days or even weeks may elapse from initial measuring to final installation. Custom manufacturing also can be expensive.

Another approach involves manufacturing and supplying retail stores with blinds in a number of “stock” sizes for each blind variety. The customer then selects a size that most closely approximates the size of the window to be covered. However, if only a small number of stock sizes are provided, the likelihood of a customer finding a stock size that fits appropriately is reduced. Providing more stock sizes can mitigate fitting difficulties; however, to do so necessarily requires retailers to take on greater inventory and provide more shelf space for the blinds being stocked.

A solution to the foregoing problems has led to a now popular approach, a so-called “size-in-store” system, in which a relatively small number of stock sizes of each blind are provided to the retail outlet. The blinds are designed in a manner such that the headrails, bottom rails and window covering materials such as slats, fabric, etc. can be trimmed at either and preferably at both ends. “Size-in-store” programs from manufacturers typically include providing the retail store outlet with a cutdown machine designed to cut the particular blinds or other window coverings. When a store handles different types of window coverings, it has been necessary to have different cutdown machines for the different products, requiring dedicating space to numerous cutdown machines. Space used for cutdown machines could be used otherwise for the display of products.

While many different types of cutdown machines exist, certain characteristics are common to many of the machines. Typically, the machines include means for cutting the headrail, the slats (or other window covering material) and the bottom rail of the window covering. In certain situations, different approaches and tools are used to cut the headrail, the slats and/or the bottom rail. In other designs, two or more components are cut by one of the cutting implements. Additionally, known cutdown machines allow for cutting both sides of the window covering, to provide a trimmed window covering having an attractive finished look with the amount that is cut from each component being approximately the same. However, the machines and methods are not always adequate in providing systems for sizing window shades efficiently and accurately.

A cutdown program may include multiple product lines requiring several different machines with which to cut them. End stop adjustments and cutting instructions vary from one cutdown machine to another. Untrained, inexperienced or new store associates often have difficulty with correctly setting and operating the machines. When mistakes are made in trimming blinds, it is often necessary to discard a blind and start over, thus impacting the profitability of the program.

Another problem that has been encountered with cutdown machines having multi-functions with multiple cutting stations is that a breakdown in a part of the machine often disables the entire machine. If the machine must be removed for repair the entire cutdown program is jeopardized.

Therefore, there is a need for a cutting apparatus for window treatments capable of customizing window treatments efficiently, to fit window dimensions specified by customers. Further, there is a need to provide a cutdown machine that can be used to cut window coverings of different styles and types. Still further, there is a need for a window covering cutdown machine that is simple to operate and capable of cutting many different types of window coverings on a single machine requiring minimal space. Still further, there is a need for an improved window covering cutdown machine that is modular so that a portion of the machine can be out of service, removed or replaced without significant interruption to other cutdown functions performed by the machine.

### SUMMARY OF THE INVENTION

The present invention provides a window covering cutdown machine that can be used for cutting window coverings of various types and of various materials, including but not limited to wood and other natural materials, faux wood, solar shades, vinyl shades, vinyl blinds, cellular blinds, and both vertical and horizontal coverings. The machine incorporates multiple discrete cutting centers or workstations grouped in removable modules in a compact arrangement that is convenient to use.

An advantageous feature of at least one form of the modular cutdown machine is that a single machine is provided for cutting common window covering types sold in cutdown programs, and fewer machines are needed requiring less space.

Another advantageous feature of at least one form of the modular cutdown machine is that while a single machine is provided, the various cutting stations are independent of one another at various locations around a product support surface. Accordingly, if one station is out of service for repair or maintenance, other work stations are not necessarily affected and can be used.

Yet another advantageous feature of at least one form of the modular cutdown machine is that the machine is modular so that if some cutting stations can be removed for repair without disabling the other cutting stations on the machine.

### BRIEF DESCRIPTION OF THE DRAWINGS

The above-mentioned and other features and advantages of this invention, and the manner of attaining them, will become more apparent and the invention will be better understood by reference to the following description of an embodiments of the invention taken in conjunction with the accompanying drawings, wherein:

FIG. 1 is a view of the front of a modular cutdown machine;

FIG. 2 is a view of the back of the modular cutdown machine;

FIG. 3 is a perspective view from the front of the modular cutdown machine showing the various modules of the machine separated from one another, and with the center module doors open;

FIG. 4 is a perspective view from the back of the modular cutdown machine showing the various modules of the machine separated from one another, and with some of the cabinet panels of the modules removed;

FIG. 5 is a perspective view from the back of the assembled modular cutdown machine;

FIG. 6 is a fragmentary view of one of the cutting modules, with protective covers removed;

FIG. 7 is a perspective view of the opposite end of the modular cutdown machine from that shown in FIG. 6, again with some of the protective covers removed;

FIG. 8 is an enlarged fragmentary view of a portion of the modular cutdown machine,

FIG. 9 is an enlarged fragmentary view showing the power connections to one of the end modules; and

FIG. 10 is an enlarged fragmentary view showing the power connections to the other of the end modules;

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

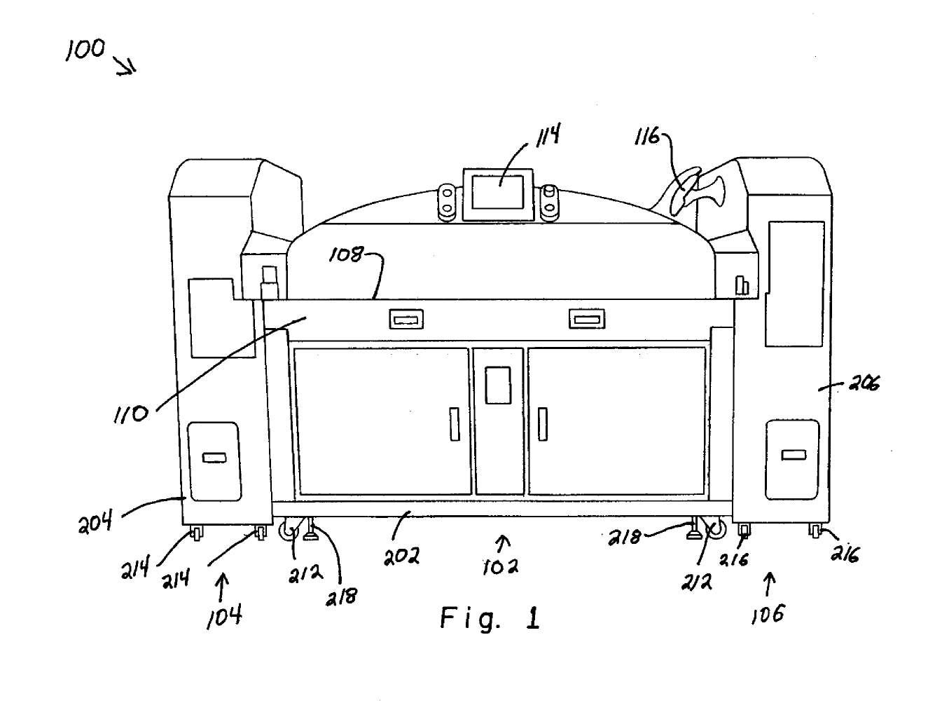

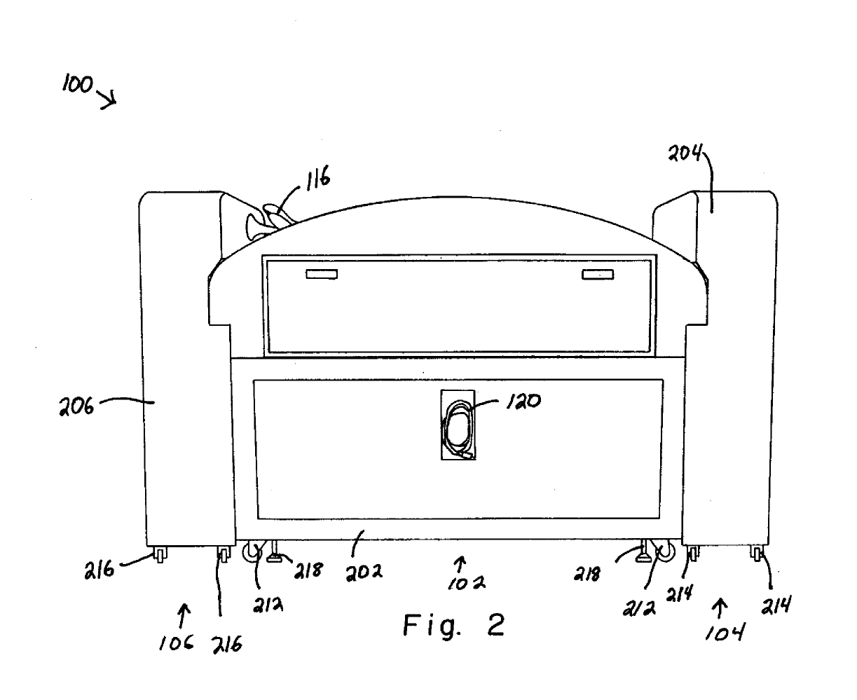

Referring now to the drawings and more particularly to FIGS. 1 and 2, there is shown a modular cutdown machine 100 which generally includes a center control module 102 and first and second end cutting modules or workstations 104, 106 on opposite ends of center control module 102. Cutdown machine 100 is a compact, multiproduct cutting center providing convenient access for cutting all common window coverings products sold through in-store cutdown programs. Accordingly, modular cutdown machine 100 is capable of cutting at least a first window covering product type in first cutting module or workstation 104 and at least a second window covering product type in second cutting module or workstation 106. Advantageously, more than a single window covering product type can be cut in each of workstations 104, 106

Center control module 102 provides both control signals and operating power sources for the various cutting instruments in cutting modules or workstations 104, 106. Center control module 102 provides a product support surface 108 in the way of a flat, table-like area of support for the various products to be cut in cutting modules or workstations 104, 106. Product support surface 108 is particularly convenient for arranging and preparing window coverings prior to cutting. At the front of product support surface 108, a pullout drawer 110 is provided for a vertical blind headrail cutdown station. An advantage of the exemplary modular cutdown machine 100 shown is that the cutdown machine will fit completely within a standard size single bay in so-called “big box” stores and home improvement stores. When cutting vertical blind headrails, which can have a headrail length (i.e. the width of the blind) that is longer than the width of a standard bay opening, drawer 110 is pulled out only a small distance for supporting the vertical blind headrail in front of the bay, thereby allowing the vertical blind headrail to extend in front of the adjacent bay next to the cutdown machine. When drawer 110 is in the closed or stowed position, cutdown machine 100 does not protrude outwardly in front of the bay. Even with drawer 110 open, intrusion into the aisle is minimal. In a

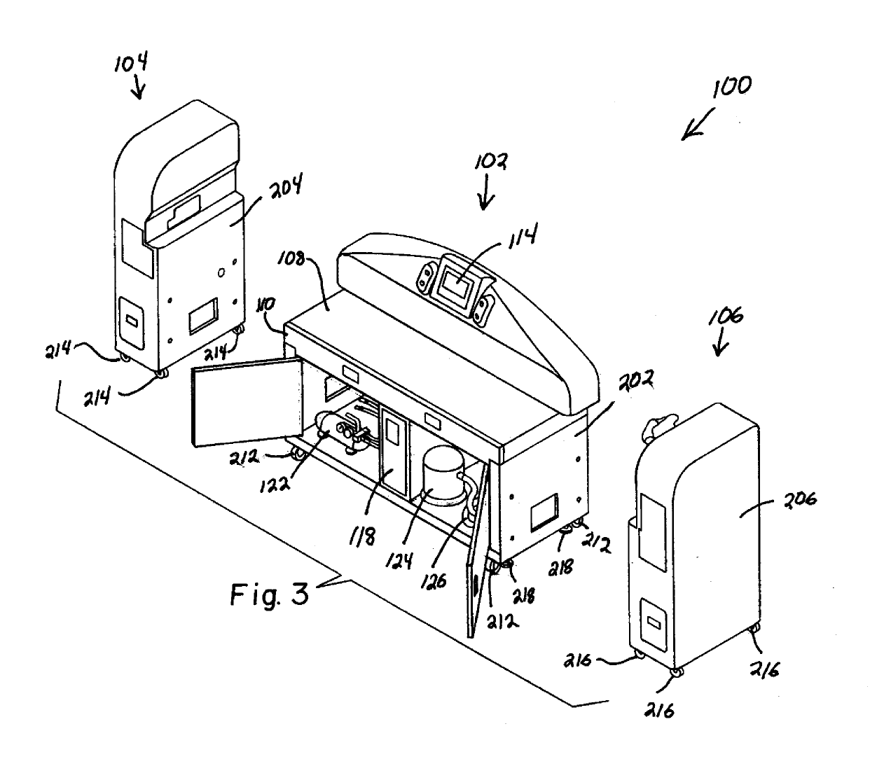

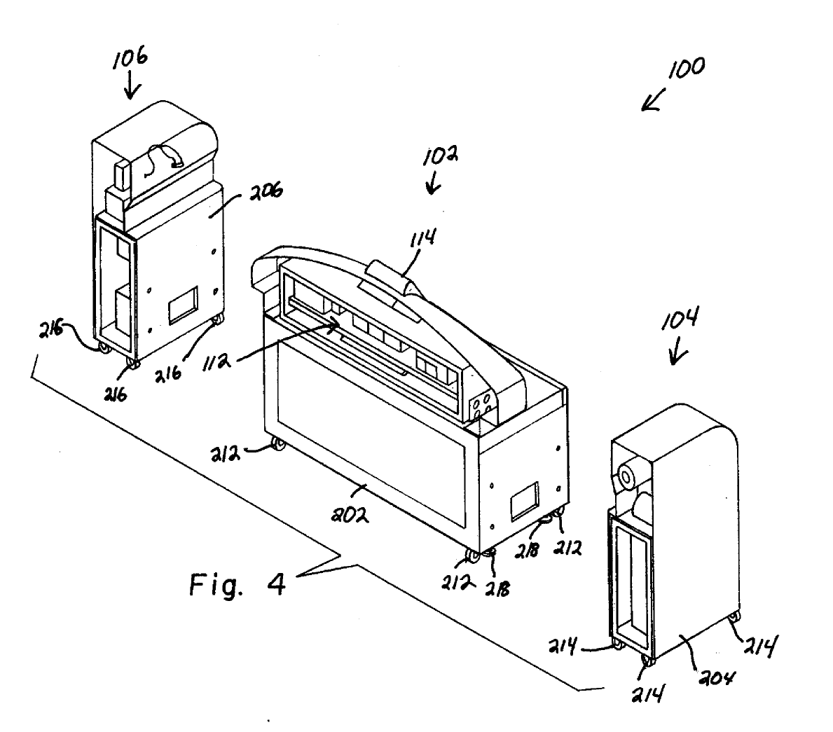

Center control module 102 provides operating power and control functions to each of first and second cutting modules or workstations 104, 106. Accordingly, as seen in FIGS. 3 & 4, center control module 102 includes a programmable logic controller (PLC) 112, a touch screen display 114 operatively connected thereto for both operator input and information display and a product barcode scanner 116 for scanning barcodes on products to be cut in either workstation 104, 106. Barcode scanner 116 automatically inputs product information to calculate automatic adjustment features of the machine. Touch screen display 114 allows operator input for information about the installation for which the product is being cut, or to the input unique product information, such as for re-cutting a previously cut product.

Center control module 102 is further provided with a power hub 118 having an electric cord 120 for connecting modular cutdown machine 100 to an electrical power source. A compressor 122 and a vacuum unit 124 with a vacuum hose 126 are also provided in center control module 102. Electric power from power hub 118 and pressurized air from compressor 122 for operating the workstations, and vacuum from vacuum unit 124 for cleanup are distributed from center control module 102 to the each of first and second cutting modules or workstations 104, 106 along with control signals from PLC 112.

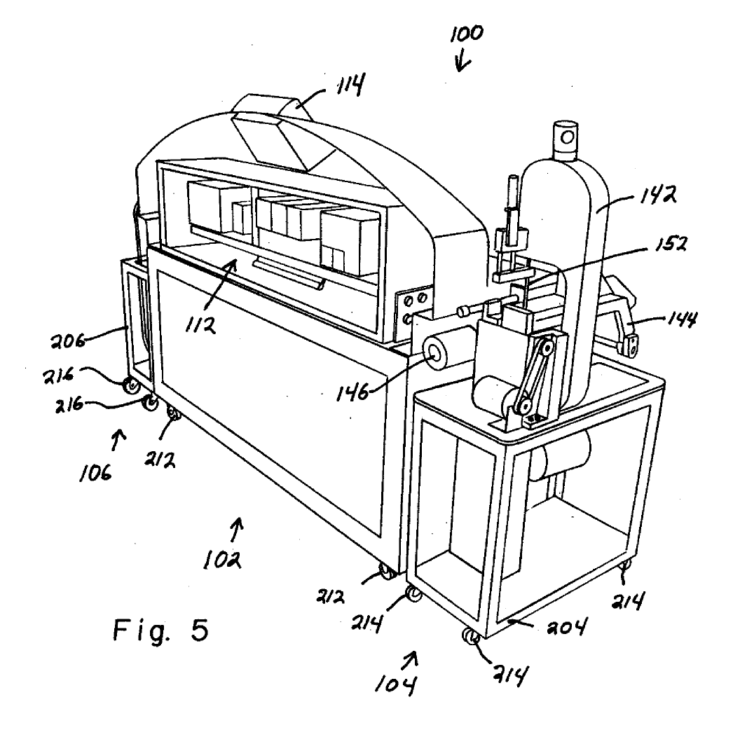

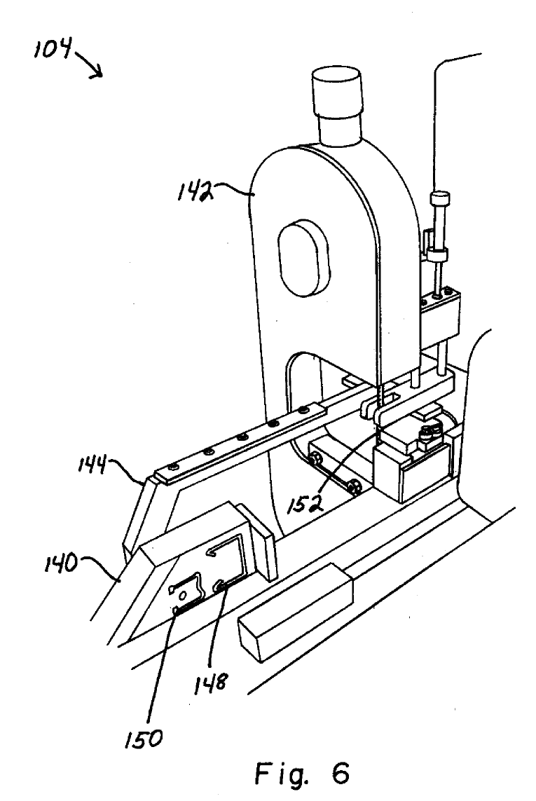

First cutting module or workstation 104 is shown in more detail in FIGS. 5 & 6. In first cutting module or workstation 104, wood and fauxwood blinds are cut using a headrail cutting die 140 and a band saw 142. An end stop 144 is provided and adjusted automatically by pneumatic operators 146 or the like for positioning the end of the blind being cut for removal of an appropriate portion of the headrail, bottom rail and slats. It should be understood that multiple die apertures can be provided for cutting head rails of different configurations, and in the exemplary embodiment shown larger and smaller apertures 148, 150 are illustrated. Die cutting apparatus are well known in the industry for cutting metal headrails, bottom rails and the like. Band saws for cutting slats and/or bottom rails are also known and can include appropriate clamping mechanisms and operators to move the product through the band saw or to move the band saw relative to the product when making a cut.

The band saw can be a standard, commercially available band saw unit with a continuous band blade 152 of suitable size and saw tooth configuration and count for cutting the materials to be cut therewith. It is expected that universal, multi-material blade types may be used, to provide versatility in the types of materials that can be cut on cutdown machine wood/faux wood cutting station, which may include metals including steel and aluminum, wood and faux wood materials, and synthetic materials such as various plastics. As those skilled in the art will understand, the band saw can also have a multi-speed operation through use of a multi-speed motor, or a belt drive system having selectable pulley variations for changing the speed of the blade. Continuously variable and multiple fixed speed drives are known, and may provide advantages in using the cutdown machine on different types of coverings for architectural openings.

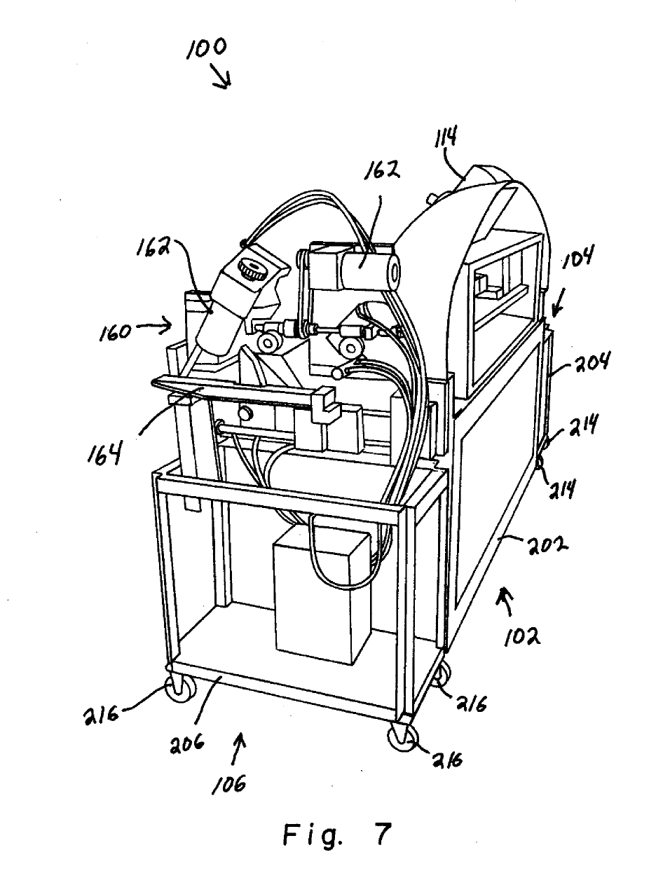

Second cutting module or workstation 106 is shown in FIG. 7. Workstation 106 can be arranged, for example, for cutting cellular blinds and/or miniblinds in a cutting station 160. A blind can be held by a vice or clamp operated by pneumatic actuators 162, and cutting performed by a knife and/or cutting dies operated by still other actuators 162. For example and not limitation, a cutting mechanism substantially as shown and described in U.S. Pat. No. 6,681,673 can be used for cutting cellular blinds. However, instead of manual operation of the cutting knife therein, mechanical or pneumatic actuators can be used operated by electric motors powered from power hub 118 or by actuators 162 powered from compressor 122. A miniblind cutting station can include die cutting apparatus for the headrail and bottom rail, and knife blade cutting apparatus for the slats of a miniblind as are known in individual miniblind cutting machines. For example and not limitation, cutting means substantially as shown and described in U.S. Pat. No. 6,178,857 can be used, either manually operated or preferably, pneumatically operated and powered from compressor 122. For example, a headrail cutting die and a bottom rail cutting die can be provided on opposite ends of a slat opening for receiving and cutting a headrail, a bottom rail and a group of slats, respectively. Die cuts of the headrail and bottom rail can be performed in known fashion, and the slats can be cut by a knife-like blade as known in the art. An automatic end stop system 162 is provided outwardly of the headrail die, bottom rail die and slat opening to engage the ends of a miniblind and establish the portion to be cut therefrom. The end stop system is automatically adjusted from data input relative to the dimensions of the miniblind to be cut and the desired final dimensions for the miniblind after cuts have been made. The headrail die and bottom rail die can be separately and independently mounted and can be adjusted relative to one another to vary the space therebetween. Accordingly, die holders for the headrail die and bottom rail die can be moved laterally by an actuator or actuators 162. The capability of providing variable spacing accommodates cutting different sizes and/or types of miniblinds having more slats or more slat volume per slat to be cut. In the closed and packaged form from which a miniblind is commonly cut, a smaller blind having fewer slats or thinner slats defines a smaller space between the headrail and bottom rail thereof than does a blind of another size or type having more slats or thicker slats. Thus, to position different blinds suitably between the headrail cutting die and the bottom rail cutting die may require different spacing between the headrail die and the bottom rail die. The adjustment can occur automatically, through software, when PLC 112 becomes aware of the type of blind being cut, either from input by the operator or from scanning bar code information on the blind during the starting sequence for cutting the blind.

Vertical blind components can be cut also with components contained in one or the other first and second cutting modules or workstations 104, 106. The pull out support surface provided by drawer 110 for vertical head rails and vertical louvers can include a rotatable belt having a cog wheel providing ratchet counts as the belt revolves. From the ratchet counts accurate linear measurement can be obtained. Cuts of the headrail and/or slats can be provided by cutting dies and/or knives extendable from either of first or second cutting modules or workstations 104, 106.

It will be readily understood by those skilled in the art that the general arrangements and configurations of cutting stations shown and described herein are merely exemplary in nature. The cutting stations shown at one end can be provided at the opposite end of the machine. Further, while suitable cutting modules or workstations are shown, it should be understood that other types of cutting modules or workstations can be used to cut other types of products or to cut similar products in other ways.

Distribution harnesses connect PLC 112, power hub 118, compressor 122 and vacuum unit 124 to first and second cutting modules or workstations 104, 106. When hooked to a source of electrical power, cutdown machine 100 is self-contained and can include cutting stations suitable for cutting most common types of window coverings supplied through cutdown programs in home improvement centers or the like. Further, the modular workstation ends of first and second cutting modules or workstations 104, 106 are easily removed for repair, servicing or replacement and are connected to center control module by readily connectable and disconnectable electric, air pressure and control lines as well as vacuum hose connections for cleanup.

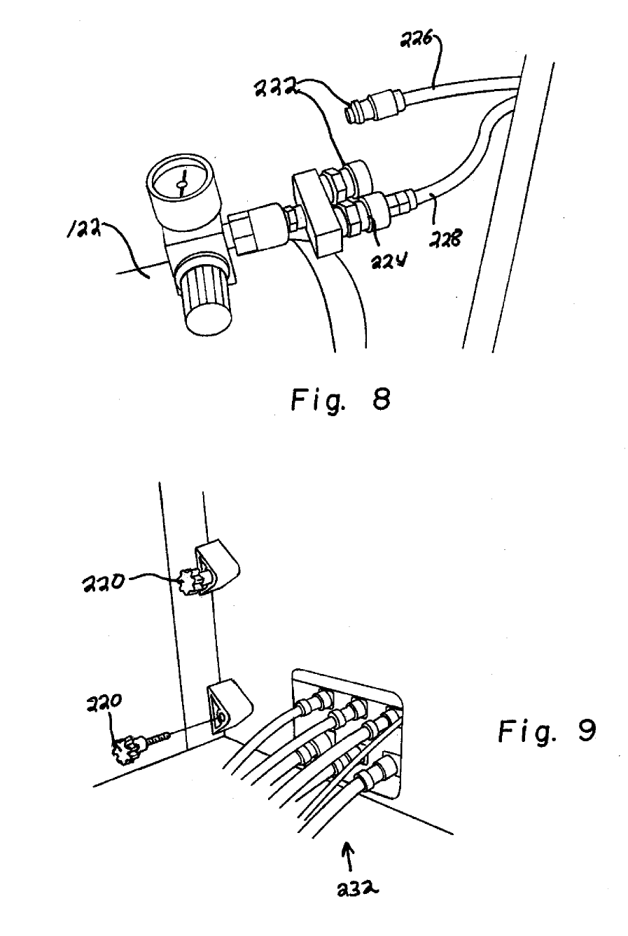

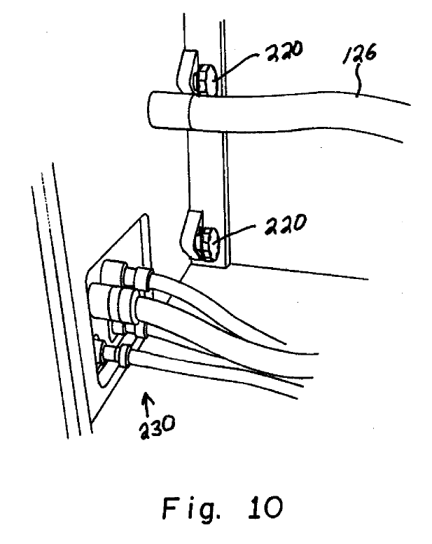

Modules 102, 104 and 106 are independent and discrete, each including a separate cabinet or housing 202, 204, and 206 respectively. Center cabinet 202 of center module 102 is movable and supported on casters 212. First cutting module or workstation cabinet 204 of first cutting module or workstation 104 is movable and supported on casters 214. Second cutting module or workstation cabinet 206 of first cutting module or workstation 106 is movable and supported on casters 216. Accordingly, each cabinet in each module is separately and independently movable relative to the others. Center module 102 can be further stabilized by threaded legs 218. A plurality of threaded fasteners 220 can be used to connect first cutting module or workstation cabinet 204 and second cutting module or workstation cabinet 206 to center cabinet 202. Quick connect type connectors can be used for connecting signal lines, electrical lines and pneumatic lines to each of the workstations. For example, quick connect pneumatic connectors 222, 224 on pneumatic lines 220 6, 228 are shown in FIG. 8 connected to compressor 122. Accordingly, a first connector array 230 (FIG. 10) and a second connector array 232 (FIG. 9) are provided between center module 102 and first and second cutting modules or workstations 104, 106. The various electric, signal and pneumatic connectors can be coded or keyed by connector type, size, configuration, shape, color or the like so that each is properly connected for operating the proper device.

When cutting a product, an operator can enter cutting information via touch screen display 114. The information entered may include the stock length and type of the blind to be cut, the desired final dimension, and whether the installation is for an inside mount or an outside mount. The stock information about the blind also can be entered by way of barcode scanner 116. An appropriate fixed scanner can be mounted on the machine for scanning, or a handheld scanner can be used. The various necessary apparatus for cutting the type of blind designated through such entry information are enabled while other components of the cutdown machine not required for cutting the particular window covering to be cut will remain disabled. Throats and openings to the internal mechanisms can be covered with guards and doors that remain closed unless the apparatus there behind is activated. Accordingly, when product data is entered either manually or by scanning, the operator is immediately directed to the proper cutting facilities in that the product cannot be inadvertently inserted in a wrong opening that remains closed. The end stops are positioned automatically in response to the data input. The blind is then inserted through the appropriate openings or dies until it engages the end stop. Thereafter, the machine is actuated by depressing activation buttons, or by enabling automatic sequencing entered at touch screen display 114. When cutting commences, the end stops can be withdrawn automatically as the product will be held in clamps or vices. By removing the end stop, cut ends of the blind can fall away into refuse receiving areas. Cutting by the band saw or by the various dies is automatic and requires no further operation. After one side of the blind has been cut, the cut end is removed from the particular cutting station which was used, the blind is rotated 180° and the yet uncut side is inserted into the appropriate cutting station. Thereafter, the machine is actuated a second time and automatically cuts the necessary amount for the final dimension desired. Cleanup is facilitated by a vacuum unit 124.

Machine 100 has an open design for easy use by store personnel. Access is open and unencumbered, with work areas being easily accessed without obstruction in front thereof. Accordingly, it is convenient to unpackage a window covering, prepare the window covering for cutting, and slide the window covering into the appropriate cutting area.

An advantageous feature of one form of the present invention is that while a combined apparatus is provided for cutting all types of blinds, the various cutting stations are independent of one another in discrete modules at opposite ends of center module 102. Accordingly, if one cutting module or workstation 104, 106 is out of service for repair or maintenance, the other cutting module or workstation 104, 106 is not necessarily affected and can be used. In one embodiment, the various dies, are held in place by screws, bolts or magnets. Accordingly, each is easily replaceable, and dies for different headrail or bottom rail profiles can be changed quickly and easily. Repair in the event of damage also is facilitated.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Various features of the invention are set forth in the following claims.

What is claimed is:

1. A modular cutdown machine for cutting window blind products of different types, said modular cutdown machine comprising:
a center control module including sources of operating power;
a first cutting module for cutting at least a first window blind product type at one end of said center control module;
a second cutting module for cutting at least a second window blind product type at an opposite end of said center control module from said first cutting module;
a first array of disconnectable power couplings from at least some of said sources of operating power to said first cutting module; and
a second array of disconnectable power couplings from at least some of said sources of operating power to said second cutting module.

2. The modular cutdown machine of claim 1; each of said modules including a separate cabinet, and said cabinet of said center control module being detachably connected to said cabinets of said first and second cutting modules.

3. The modular cut down machine of claim 1, said center control module having a vacuum cleaner therein, and a vacuum hose connecting said vacuum cleaner to at least one of said first and second cutting modules.

4. The modular cut down machine of claim 1, said center control module having an air compressor therein, and at least one pressure line connecting said compressor to at least one of said first and second cutting modules.

5. The modular cut down machine of claim 1, said center control module having a programmable logic controller therein operatively connected to at least one of said first and second cutting modules.

6. The modular cut down machine of claim 5, including a bar code scanner providing input to said programmable logic controller for at least said first and second window blind product types.

7. The modular cut down machine of claim 5, said center control module having a touch screen display operatively connected to said programmable logic controller.

8. The modular cut down machine of claim 1, said center control module having an electric power hub operatively connected to at least one of said first and second cutting modules.

9. The modular cut down machine of claim 1, said sources of operating power including a compressor and an electric power hub.

10. The modular cut down machine of claim 9, each of said center control module and said first and second cutting modules having discrete floor supports.

11. The modular cutdown machine of claim 9; each of said modules including a cabinet, and said cabinet of said center control module being detachably connected to said cabinets of said first and second cutting modules by threaded fasteners.

12. The modular cut down machine of claim 11, said center control module having a programmable logic controller therein operatively connected to at least one of said first and second cutting modules.

13. The modular cut down machine of claim 12, including a bar code scanner providing input to said programmable logic controller for at least said first and second window blind product types.

14. The modular cut down machine of claim 13, said center control module having a touch screen display operatively connected to said programmable logic controller.

15. The modular cut down machine of claim 14, said center control module having a product support surface in alignment with said first and second cutting modules.

16. The modular cut down machine of claim 1, said center control module having a product support surface in alignment with said first and second cutting modules.

17. The modular cut down machine of claim 16, said center control module having a pull out drawer defining a second product support surface.

18. A modular cutdown machine for cutting window blind products of different types, said modular cutdown machine comprising:
a center control module including sources of operating power;
a first cutting module for cutting at least a first window blind product type at one end of said center control module;
a second cutting module for cutting at least a second window blind product type at an opposite end of said center control module from said first cutting module;
said first cutting module connected only to said center control module for operating power and for operating control; and
said second cutting module connected only to said center control module for operating power and for operating control.

19. The modular cutdown machine of claim 18, said center control module including a power hub and a compressor operatively connected to said first and second cutting modules.

20. A modular cutdown machine of claim 18, said center control module including a programmable logic controller operatively connected to said first and second cutting modules.
